(19) United States
(12) Patent Application Publication
(10) Pub. No.: US 2023/0186397 A1
(43) Pub. Date: Jun. 15, 2023

(54) SYSTEMS AND METHODS FOR PROVIDING RENEWING CARBON OFFSETS

(71) Applicant: BlueOwl, LLC, San Francisco, CA (US)

(72) Inventor: Kenneth Jason Sanchez, San Francisco, CA (US)

(21) Appl. No.: 17/821,867

(22) Filed: Aug. 24, 2022

Related U.S. Application Data
(63) Continuation of application No. PCT/US2021/018233, filed on Feb. 16, 2021.
(60) Provisional application No. 62/981,804, filed on Feb. 26, 2020.

(51) Int. Cl. G06Q 40/08; G06Q 30/018; G06Q 50/30

(52) U.S. Cl. CPC G06Q 40/08; G06Q 30/018; G06Q 50/30

(57) ABSTRACT

Method and system for providing renewing carbon offsets. For example, the method includes collecting driving data for vehicle trips made by a user, analyzing the driving data to determine a level of mindful driving, determining a level of carbon offset reward based upon the level of mindful driving, determining an amount of total carbon emission of the user, and providing an amount of carbon offset reward based upon the level of carbon offset reward and the amount of total carbon emission, where the amount of carbon offset reward includes a first amount for planting a first set of trees at a first time and a second amount for planting a second set of trees at a second time with the first time preceding the second time by a time duration that is shorter than or equal to the lifespan of each of the first set of trees.

### CROSS-REFERENCE TO RELATED APPLICATIONS

This application claims priority to U.S. Provisional Patent Application No. 62/981,804, filed Feb. 26, 2020, incorporated by reference herein for all purposes.

### FIELD OF THE DISCLOSURE

Some embodiments of the present disclosure are directed to providing renewing carbon offsets. More particularly, certain embodiments of the present disclosure provide methods and systems for offering carbon offsets to compensate for carbon emissions generated during a user's vehicle trips. Merely by way of example, the present disclosure has been applied to offering carbon offsets through renewing carbon sequestration actions such as continuous self-funded tree planting. But it would be recognized that the present disclosure has much broader range of applicability.

### BACKGROUND OF THE DISCLOSURE

Carbon emissions from vehicles represent a major contributor to climate change. While new vehicle technologies have been developed to curb carbon emissions, the continued use of vehicles for private transportation will cause the amount of carbon emissions to remain high or even increase. Hence it is highly desirable to develop additional approaches that compensate for the release of these carbon emissions.

### BRIEF SUMMARY OF THE DISCLOSURE

Some embodiments of the present disclosure are directed to providing renewing carbon offsets. More particularly, certain embodiments of the present disclosure provide methods and systems for offering carbon offsets to compensate for carbon emissions generated during a user's vehicle trips. Merely by way of example, the present disclosure has been applied to offering carbon offsets through renewing carbon sequestration actions such as continuous self-funded tree planting. But it would be recognized that the present disclosure has much broader range of applicability.

According to certain embodiments, a method for providing renewing carbon offsets includes collecting driving data for one or more vehicle trips made by a user. The driving data include information related to a mindful driving behavior of the user. Also, the method includes analyzing the driving data to determine a level of mindful driving of the user. Additionally, the method includes determining a level of carbon offset reward based at least in part upon the level of mindful driving of the user and an amount of total carbon emission of the user. Moreover, the method includes providing an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a time duration that is shorter than or equal to a lifespan of each of the one or more first trees.

According to some embodiments, a method for providing renewing carbon offsets includes collecting driving data for one or more vehicle trips made by a user. The driving data include information related to a mindful driving behavior of the user. Also, the method includes analyzing the driving data to determine a level of mindful driving of the user. Additionally, the method includes determining a level of carbon offset reward based at least in part upon the level of mindful driving of the user and an amount of total carbon emission of the user. Moreover, the method includes providing an amount of carbon offset reward based at least in part upon the level of carbon offset reward and the amount of total carbon emission. The amount of carbon offset reward includes a first amount for planting one or more first trees at a first time and a second amount for planting one or more second trees at a second time. Each of the one or more first trees corresponds to a first lifespan and each of the one or more second trees corresponds to a second lifespan. After the first lifespan, the one or more second trees remain alive as replacements for the one or more first trees until the end of the second lifespan.

According to certain embodiments, a computing device for providing renewing carbon offsets includes one or more processors and a memory that stores instructions for execution by the one or more processors. The instructions, when executed, cause the one or more processors to collect driving data for one or more vehicle trips made by a user. The driving data include information related to a mindful driving behavior of the user. Also, the instructions, when executed, cause the one or more processors to analyze the driving data to determine a level of mindful driving of the user. Additionally, the instructions, when executed, cause the one or more processors to determine a level of carbon offset reward based at least in part upon the level of mindful driving of the user and an amount of total carbon emission of the user. Moreover, the instructions, when executed, cause the one or more processors to provide an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a time duration that is shorter than or equal to a lifespan of each of the one or more first trees.

According to some embodiments, a non-transitory computer-readable medium stores instructions for providing renewing carbon offsets. The instructions are executed by one or more processors of a computing device. The non-transitory computer-readable medium includes instructions to collect driving data for one or more vehicle trips made by a user. The driving data include information related to a mindful driving behavior of the user. Also, the non-transitory computer-readable medium includes instructions to analyze the driving data to determine a level of mindful driving of the user. Additionally, the non-transitory computer-readable medium includes instructions to determine a level of carbon offset reward based at least in part upon the level of mindful driving of the user and an amount of total carbon emission of the user. Moreover, the non-transitory computer-readable medium includes instructions to provide an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a time duration that is shorter than or equal to a lifespan of each of the one or more first trees.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1A and FIG. 1B are a simplified method for providing renewing carbon offsets according to certain embodiments of the present disclosure.

FIG. 2 is a simplified method for providing renewing carbon offsets according to some embodiments of the present disclosure.

FIG. 3 is a simplified system for providing renewing carbon offsets according to certain embodiments of the present disclosure.

FIG. 4 to FIG. 11 are simplified diagrams showing a system for providing renewing carbon offsets according to some embodiments of the present disclosure.

### DETAILED DESCRIPTION OF THE DISCLOSURE

Some embodiments of the present disclosure are directed to providing renewing carbon offsets. More particularly, certain embodiments of the present disclosure provide methods and systems for offering carbon offsets to compensate for carbon emissions generated during a user's vehicle trips. Merely by way of example, the present disclosure has been applied to offering carbon offsets through renewing carbon sequestration actions such as continuous self-funded tree planting. But it would be recognized that the present disclosure has much broader range of applicability.

As described herein, carbon offsets (e.g., carbon credits) are used to measure the removal of certain amounts of carbon dioxide and/or other greenhouse gases (e.g., nitrous oxide, methane, perfluorocarbons, hydrofluorocarbons, and/or sulfur hexafluoride) from the atmosphere. According to various embodiments, to offset carbon emissions, one or more trees are planted continuously through self-funding to recapture and store the released carbon.

### I. One or More Methods for Providing Renewing Carbon Offsets According to Certain Embodiments

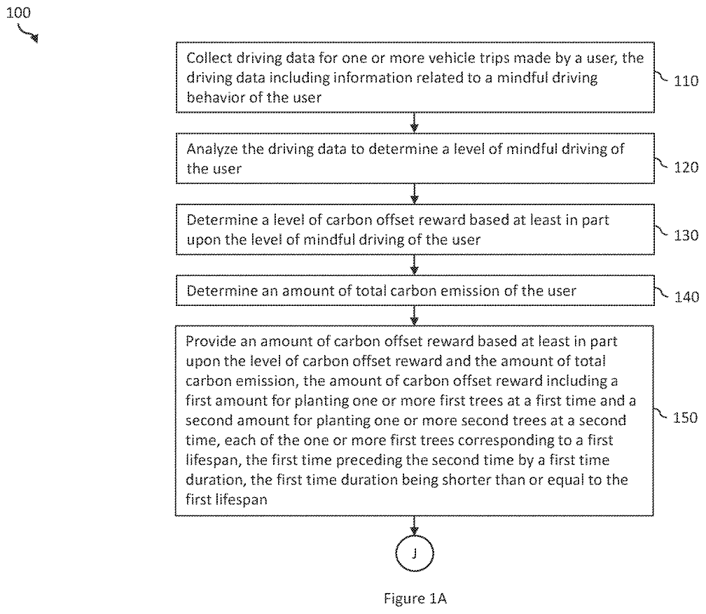

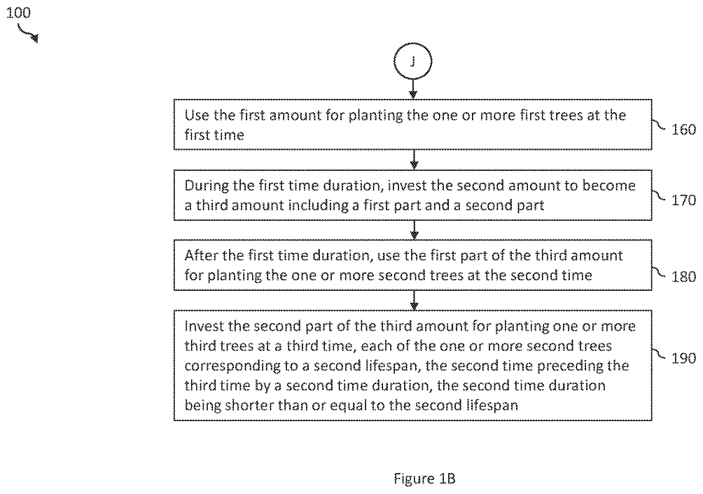

FIG. 1A and FIG. 1B are a simplified method for providing renewing carbon offsets according to certain embodiments of the present disclosure. The diagrams are merely examples, which should not unduly limit the scope of the claims. One of ordinary skill in the art would recognize many variations, alternatives, and modifications. The method 100 includes process 110 for collecting driving data for vehicle trips made by a user, process 120 for determining a level of mindful driving, process 130 for determining a level of carbon offset reward, process 140 for determining an amount of total carbon emission, process 150 for providing an amount of carbon offset reward including a first amount for planting first trees at a first time and a second amount for planting second trees at a second time, process 160 for using the first amount for planting the first trees at the first time, process 170 for investing the second amount to become a third amount, process 180 using a first part of the third amount for planting the second trees at the second time, and process 190 for investing a second part of the third amount for planting third trees at a third time. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, the driving data are collected for one or more first vehicle trips made by the user according to some embodiments. As an example, the driving data include information related to a mindful driving behavior of the user. For example, the driving data indicate how careful the user is in driving a vehicle, such as how frequently the user drives, type of maneuvers that the user makes while driving (e.g., hard cornering, hard braking, sudden acceleration, smooth acceleration, slowing before turning, etc.), types of road that the user drives on (e.g., highways, local roads, off-roads, etc.), number of reported accidents/collisions, types of dangerous driving events (e.g., cell phone usage while driving, eating while driving, falling asleep while driving, etc.), and/or types of safe driving events (e.g., maintaining safe following distance, turning on headlights, observing traffic lights, yielding to pedestrians, obeying speed limits, etc.).

According to certain embodiments, the driving data are collected from one or more sensors associated with the vehicle operated by the user. For example, the one or more sensors include any type and number of accelerometers, gyroscopes, magnetometers, barometers, location sensors (e.g., GPS sensors), tilt sensors, yaw rate sensors, speedometers, brake sensors, airbag deployment sensors, headlight sensors, steering angle sensors, gear position sensors, proximity detectors, and/or any other suitable sensors that measure vehicle state and/or operation. In some embodiments, the one or more sensors are part of or located in the vehicle. In certain embodiments, the one or more sensors are part of a computing device (e.g., a mobile device of the user) that is connected to the vehicle while the vehicle is in operation. According to some embodiments, the driving data are collected continuously or at predetermined time intervals. According to certain embodiments, the driving data are collected based on a triggering event. For example, the driving data are collected when each sensor has acquired a threshold amount of sensor measurements.

At the process 120, the driving data are analyzed to determine the level of mindful driving of the user according to certain embodiments. For example, a high level of mindful driving is determined if analysis of the driving data shows that the user always exercises safe driving with no reported accidents/collisions. As an example, a medium level of mindful driving is determined if analysis of the driving data shows that the user exercises safe driving but has one or two reported accidents/collisions. For example, a low level of mindful driving is determined if analysis of the driving data shows that the user exercises reckless driving with multiple reported accidents/collisions. In some embodiments, the level of mindful driving is represented as a numerical score. For example, a score of 90 and above indicates a high level of mindful driving of the user. In certain embodiments, mindful driving is used as a measure that incorporates collision risk, gas consumption, and/or other factors related to driving. In some embodiments, the level of mindful driving is proxied by claims data, mileage data, and/or other data related to mindful driving behaviors.

According to certain embodiments, the driving data are provided to a model (e.g., a machine learning model, a statistical model, etc.) to determine the level of mindful driving of the user. In certain embodiments, the model has been trained, and the trained model possesses existing knowledge of which features in the driving data are desirable or useful in determining whether the user exercises safe or unsafe driving. For example, determining the level of mindful driving involves that the trained model analyzes the driving data based upon the existing knowledge. As an example, analyzing the driving data includes various tasks such as performing feature extractions, applying pattern recognition, and/or other suitable tasks.

According to some embodiments, the model is an artificial neural network (e.g., a convolutional neural network, a recurrent neural network, a modular neural network, etc.) and the driving data are analyzed by the artificial neural network to determine mindful driving features that indicate whether safe or unsafe driving is being exercised. For example, obeying the speed limit is considered safe driving. As an example, slowing down while making a turn is considered safe driving. For example, texting on a cell phone while driving is considered unsafe driving. As an example, maintaining a tight following distance is considered unsafe driving. In some embodiments, the artificial neural network has been trained, and the trained artificial neural network possesses existing knowledge of which mindful driving features are desirable or useful in terms of determining the level of mindful driving. For example, determining the level of mindful driving involves that the trained artificial network analyzes the mindful driving features based upon the existing knowledge.

In certain embodiments, a level of insurance discount is determined based at least in part upon the level of mindful driving of the user. For example, high levels of mindful driving result in high levels of insurance discount. In various embodiments, the level of mindful driving is used to determine an insurance policy, an insurance marketing offer, an eligibility qualification, and/or an insurance quote.

In some embodiments, an adjustment to an insurance premium for the user is generated based at least in part upon the level of insurance discount and an amount of insurance premium (e.g., an original insurance premium of the user). For example, the adjustment to the insurance premium is in the form of monetary payments (e.g., cash) that the user receives. In certain embodiments, the level of insurance discount is a percentage value that is applied to adjust (e.g., reduce) the amount of insurance premium. In some embodiments, the level of insurance discount is a lump sum of cash that is applied to adjust (e.g., reduce) the amount of insurance premium. In certain embodiments, the level of insurance discount is applied to the amount of insurance premium at a future time (e.g., at a premium renewal date).

At the process 130, the level of carbon offset reward is determined based at least in part upon the level of mindful driving of the user according to some embodiments. For example, a high level of mindful driving produces a high level of carbon offset reward whereas a low level of mindful driving results in a low level of carbon offset reward. In certain embodiments, as long as the user maintains a high level of mindful driving, the level of carbon offset reward will be equally high regardless of how much driving has taken place.

At the process 140, the amount of total carbon emission of the user is determined according to certain embodiments. For example, the amount of total carbon emission represents how much carbon pollution (e.g., carbon dioxide) the user has generated by driving the vehicle during the one or more first vehicle trips. In some embodiments, the amount of total carbon emission represents at least a part of the user's overall carbon footprint.

In some embodiments, fuel-consumption driving data and/or vehicle information are collected for one or more second vehicle trips made by the user. For example, the fuel-consumption driving data indicate a quantity of fuel (e.g., gasoline) that has been consumed in operating the vehicle during the one or more second vehicle trips. As an example, the fuel-consumption driving data indicate how much fuel has been consumed in view of different driving conditions (e.g., traffic conditions, road conditions, weather conditions, terrain conditions). For example, the vehicle information indicate various specifications of the vehicle operated by the user, such as model/year/make, type (e.g., hybrid), engine size, fuel economy (e.g., miles per gallon) and/or other suitable information.

According to certain embodiments, the one or more second vehicle trips are the same as the one or more first vehicle trips made by the user. For example, the driving data and the fuel-consumption driving data are collected from the same set of vehicle trips. According to some embodiments, the one or more second vehicle trips are different from the one or more first vehicle trips made by the user. As an example, different and separate sets of vehicle trips are used to collect the driving data and the fuel-consumption driving data respectively. In certain embodiments, the one or more first vehicle trips overlap with the one or more second vehicle trips. For example, at least some of the driving data are collected during the one or more first vehicle trips and during the one or more second vehicle trips. As an example, at least some of the fuel-consumption driving data are collected during the one or more first vehicle trips and during the one or more second vehicle trips. In some embodiments, the one or more first vehicle trips differ in time from the one or more second vehicle trips. For example, the driving data are collected during an initial set of vehicle trips while the fuel-consumption driving data and the vehicle information are collected during a subsequent set of vehicle trips or vice versa.

In certain embodiments, the fuel-consumption driving data are collected from various sensors (e.g., fuel level sensors, exhaust sensors, speedometers, etc.) associated with the vehicle operated by the user. In some embodiments, the vehicle information are identified using a unique identifier of the vehicle (e.g., vehicle identification number (VIN)), which may be supplied by the user or collected from a manufacturer of the vehicle.

According to various embodiments, the fuel-consumption driving data and the vehicle information are analyzed using any suitable model (e.g., machine learning model, statistical model, etc.), mathematical formula, algorithm, and/or computational method (e.g., decision tree, Bayesian network, finite-state machine, support vector machine, etc.) to determine the amount of total carbon emission.

In some embodiments, fueling data are collected for the one or more second vehicle trips made by the user. For example, the fueling data indicate how much fuel was consumed by the vehicle during the one or more second vehicle trips. In certain embodiments, the fueling data are supplied by the user. As an example, the user manually inputs a certain amount of fuel that was added between a set of dates in which the one or more second vehicle trips occurred. In some embodiments, the fueling data are automatically collected from one or more sensors (e.g., a fuel gauge) associated with the vehicle.

According to various embodiments, the fueling data are analyzed using any suitable model (e.g., machine learning model, statistical model, etc.), mathematical formula, algorithm, and/or computational method (e.g., decision tree, Bayesian network, finite-state machine, support vector machine, etc.) to determine the amount of total carbon emission.

At the process 150, the amount of carbon offset reward is provided based at least in part upon the level of carbon offset reward and the amount of total carbon emission according to some embodiments. In certain embodiments, the amount of carbon offset reward corresponds to an amount of cost (e.g., money) needed for the planting of trees and/or other plants to compensate for the amount of total carbon emission generated by the user during the user's vehicle trips.

According to various embodiments, the planting of trees is carried out in a renewable fashion in which new trees are planted when already planted trees die. For example, when a tree dies, the carbon stored in the tree is released back to the atmosphere. As an example, the planting of a new tree will ensure that the carbon is permanently recaptured and stored in a tree. In some embodiments, the planting of trees is performed by a company or entity engaged in carbon emission reduction projects/programs. In certain embodiments, the user can select a particular type of tree to plant and a location to plant a tree.

In some embodiments, the amount of carbon offset reward includes the first amount for planting one or more first trees at the first time, and the second amount for planting one or more second trees at the second time. For example, the first time precedes the second time by a first time duration that is shorter than or equal to a first lifespan of each of the one or more first trees. In some examples, if a tree has a lifespan of 25 years, then a new tree is planted at the 15-year mark to ensure that there will always be a tree to store the carbon in the original tree.

In certain embodiments, a planted tree is individually tracked to monitor the condition and lifespan of the tree. For example, when the tree is dying or dies, a notification is generated to indicate that a new tree needs to be planted to compensate for the dying or dead tree.

At the process 160, the first amount of carbon offset reward is used to plant the one or more first trees at the first time according to some embodiments. At the process 170, the second amount of carbon offset reward is invested (e.g., in stocks, mutual funds, savings account, etc.) during the first time duration according to certain embodiments. For example, the second amount is invested so that it can grow to become a third amount needed for the subsequent planting of new trees at later times. In some embodiments, the third amount includes a first part and a second part.

At the process 180, after the first time duration, the first part of the third amount is used to plant the one or more second trees at the second time according to some embodiments. At the process 190, the second part of the third amount is invested for planting one or more third trees at a third time according to certain embodiments. For example, the second time precedes the third time by a second time duration that is shorter than or equal to a second lifespan of each of the one or more second trees. In some embodiments, the second part is invested so that it can grow to become a fourth amount that includes a third part and a fourth part. For example, the third part is used to plant the one or more third trees at the third time, and the fourth part is again invested for the planting of additional or future trees (e.g., planting of one or more fourth trees at a fourth time).

According to various embodiments, the process 150, the process 160, the process 170, the process 180, and/or the process 190 are repeated continuously unless interrupted by external instructions so that any carbon emissions generated by the user are effectively captured and stored for a predetermined period of time. For example, the predetermined period of time is longer than one lifespan of a tree. In some embodiments, the amount of carbon offset reward is always divided into two parts, with one part being used to plant one or more present trees and the other part being invested such that additional trees are planted in the future to replace and/or supplement the one or more present trees.

In certain embodiments, the process 150, the process 160, the process 170, the process 180, and/or the process 190 operate to continuously capture, store and recapture carbon emissions generated by the user in the form of an eternal tree. As an example, the process 150, the process 160, the process 170, the process 180, and/or the process 190 are repeated for an infinite number of times.

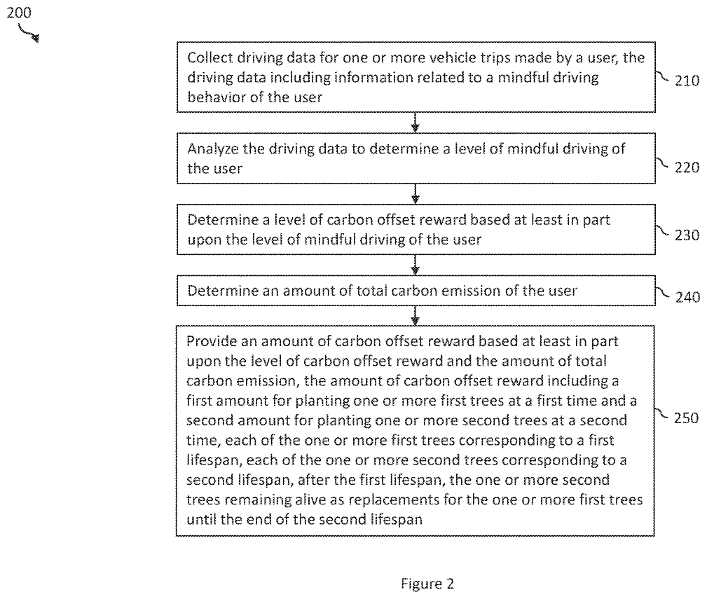

FIG. 2 is a simplified method for providing renewing carbon offsets according to some embodiments of the present disclosure. The diagrams are merely examples, which should not unduly limit the scope of the claims. One of ordinary skill in the art would recognize many variations, alternatives, and modifications. The method 200 includes process 210 for collecting driving data for vehicle trips made by a user, process 220 for determining a level of mindful driving, process 230 for determining a level of carbon offset reward, process 240 for determining an amount of total carbon emission, and process 250 for providing an amount of carbon offset reward including a first amount for planting first trees at a first time and a second amount for planting second trees at a second time. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, the driving data are collected for one or more first vehicle trips made by the user according to some embodiments. As an example, the driving data include information related to a mindful driving behavior of the user. For example, the driving data indicate how careful the user is in driving a vehicle (e.g., how frequently the user drives, number of reported accidents/collisions, types of dangerous driving events, types of safe driving events, etc.).

According to certain embodiments, the driving data are collected from one or more sensors associated with the vehicle operated by the user (e.g., accelerometers, gyroscopes, barometers, GPS sensors, etc.). For example, the one or more sensors are part of a computing device that is connected to the vehicle while the vehicle is in operation.

At the process 220, the driving data are analyzed to determine the level of mindful driving of the user according to certain embodiments. For example, if analysis of the driving data shows that the user always exercises safe driving with no reported accidents/collisions, then a high level of mindful driving is determined. As an example, if analysis of the driving data shows that the user exercises safe driving but has one or two reported accidents/collisions, then a medium level of mindful driving is determined. For example, if analysis of the driving data shows that the user exercises reckless driving with multiple reported accidents/collisions, then a low level of mindful driving is determined.

At the process 230, the level of carbon offset reward is determined based at least in part upon the level of mindful driving of the user according to some embodiments. For example, a high level of mindful driving produces a high level of carbon offset reward whereas a low level of mindful driving results in a low level of carbon offset reward.

At the process 240, the amount of total carbon emission of the user is determined according to certain embodiments. For example, the amount of total carbon emission represents how much carbon pollution the user has generated by driving the vehicle during the one or more first vehicle trips.

In some embodiments, fuel-consumption driving data and/or vehicle information are collected for one or more second vehicle trips made by the user. For example, the fuel-consumption driving data indicate a quantity of fuel that has been consumed in operating the vehicle during the one or more second vehicle trips. As an example, the vehicle information indicate various specifications of the vehicle operated by the user (e.g., model/year/make). In certain embodiments, the fuel-consumption driving data are collected from various sensors associated with the vehicle operated by the user, and the vehicle information are identified using a VIN.

According to various embodiments, the fuel-consumption driving data and the vehicle information are analyzed using any suitable model, mathematical formula, algorithm, and/or computational method to determine the amount of total carbon emission.

In certain embodiments, the one or more second vehicle trips are the same as the one or more first vehicle trips made by the user. For example, the driving data and the fuel-consumption driving data are collected from the same set of vehicle trips. In some embodiments, the one or more second vehicle trips are different from the one or more first vehicle trips made by the user. As an example, different and separate sets of vehicle trips are used to collect the driving data and the fuel-consumption driving data respectively. In certain embodiments, the one or more first vehicle trips overlap with the one or more second vehicle trips. For example, at least some of the driving data are collected during the one or more first vehicle trips and during the one or more second vehicle trips. As an example, at least some of the fuel-consumption driving data are collected during the one or more first vehicle trips and during the one or more second vehicle trips.

In some embodiments, fueling data are collected for the one or more second vehicle trips made by the user. For example, the fueling data indicate how much fuel was consumed by the vehicle during the one or more second vehicle trips. According to various embodiments, the fueling data are analyzed using any suitable model, mathematical formula, algorithm, and/or computational method to determine the amount of total carbon emission.

At the process 250, the amount of carbon offset reward is provided based at least in part upon the level of carbon offset reward and the amount of total carbon emission according to some embodiments. In certain embodiments, the amount of carbon offset reward corresponds to an amount of cost needed to renewably plant trees in order to compensate for the amount of total carbon emission generated by the user during the user's vehicle trips.

In some embodiments, the amount of carbon offset reward includes the first amount for planting one or more first trees at the first time, and the second amount for planting one or more second trees at the second time. In certain embodiments, each of the one or more first trees corresponds to a first lifespan, and each of the one or more second trees corresponds to a second lifespan. For example, after the first lifespan, the one or more second trees remain alive as replacements for the one or more first trees until the end of the second lifespan.

In certain embodiments, the second amount of carbon offset reward includes two parts with one part being used to plant the one or more second trees at the second time and another part being invested to plant one or more third trees. In some embodiments, each of the one or more third trees corresponds to a third lifespan. For example, after the second lifespan, the one or more third trees remain alive as replacements for the one or more second trees until the end of the third lifespan.

According to various embodiments, the process 250 is repeated continuously unless interrupted by external instructions so that any carbon emissions generated by the user are effectively captured and stored. In certain embodiments, the process 250 operates to continuously capture, store and recapture carbon emissions generated by the user in the form of an eternal tree.

### II. One or More Systems for Providing Renewing Carbon Offsets According to Certain Embodiments

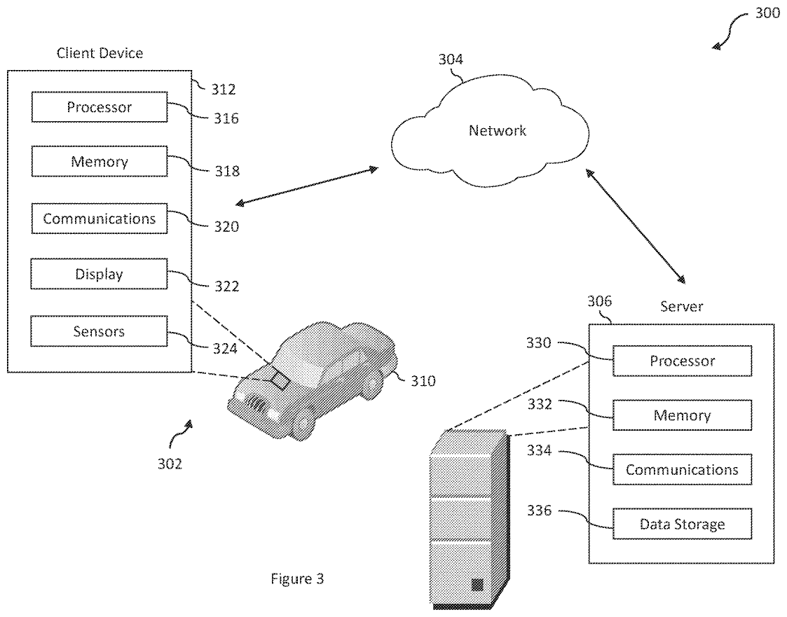

FIG. 3 is a simplified system for providing renewing carbon offsets according to certain embodiments of the present disclosure. This diagram is merely an example, which should not unduly limit the scope of the claims. One of ordinary skill in the art would recognize many variations, alternatives, and modifications. The system 300 includes a vehicle system 302, a network 304, and a server 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the system 300 is used to implement the method 100 and/or the method 200. According to certain embodiments, the vehicle system 302 includes a vehicle 310 and a client device 312 associated with the vehicle 310. For example, the client device 312 is an on-board computer embedded or located in the vehicle 310. As an example, the client device 312 is a mobile device (e.g., a smartphone) that is connected (e.g., via wired or wireless links) to the vehicle 310. As an example, the client device 312 includes a processor 316 (e.g., a central processing unit (CPU), a graphics processing unit (GPU)), a memory 318 (e.g., random-access memory (RAM), read-only memory (ROM), flash memory), a communications unit 320 (e.g., a network transceiver), a display unit 322 (e.g., a touchscreen), and one or more sensors 324 (e.g., an accelerometer, a gyroscope, a magnetometer, a barometer, a GPS sensor).

In some embodiments, the vehicle 310 is operated by the user. In certain embodiments, multiple vehicles 310 exist in the system 300 which are operated by respective users. As an example, during vehicle trips, the one or more sensors 324 monitor the vehicle 310 by collecting data associated with various operating parameters of the vehicle, such as speed, acceleration, braking, location, engine status, fuel level, as well as other suitable parameters. In certain embodiments, the collected data include vehicle telematics data. According to some embodiments, the data are collected continuously, at predetermined time intervals, and/or based on a triggering event (e.g., when each sensor has acquired a threshold amount of sensor measurements). In various embodiments, the collected data represent the driving data in the method 100 and/or the method 200.

According to certain embodiments, the collected data are stored in the memory 318 before being transmitted to the server 306 using the communications unit 320 via the network 304 (e.g., via a local area network (LAN), a wide area network (WAN), the Internet). In some embodiments, the collected data are transmitted directly to the server 306 via the network 304. In certain embodiments, the collected data are transmitted to the server 306 via a third party. For example, a data monitoring system stores any and all data collected by the one or more sensors 324 and transmits those data to the server 306 via the network 304 or a different network.

According to certain embodiments, the server 306 includes a processor 330 (e.g., a microprocessor, a microcontroller), a memory 332, a communications unit 334 (e.g., a network transceiver), and a data storage 336 (e.g., one or more databases). In some embodiments, the server 306 is a single server, while in certain embodiments, the server 306 includes a plurality of servers with distributed processing. In FIG. 3, the data storage 336 is shown to be part of the server 306. In some embodiments, the data storage 336 is a separate entity coupled to the server 306 via a network such as the network 304. In certain embodiments, the server 306 includes various software applications stored in the memory 332 and executable by the processor 330. For example, these software applications include specific programs, routines, or scripts for performing functions associated with the method 100 and/or the method 200. As an example, the software applications include general-purpose software applications for data processing, network communication, database management, web server operation, and/or other functions typically performed by a server.

According to various embodiments, the server 306 receives, via the network 304, the data collected by the one or more sensors 324 using the communications unit 334 and stores the data in the data storage 336. For example, the server 306 then processes the data to perform one or more processes of the method 100 and/or one or more processes of the method 200.

According to certain embodiments, any related information determined or generated by the method 100 and/or the method 200 (e.g., mindful driving score, adjustment to insurance premium, amount of carbon offset reward, planting of current and/or future trees, etc.) are transmitted back to the client device 312, via the network 304, to be provided (e.g., displayed) to the user via the display unit 322.

In some embodiments, one or more processes of the method 100 and/or one or more processes of the method 200 are performed by the client device 312. For example, the processor 316 of the client device 312 processes the data collected by the one or more sensors 324 to perform one or more processes of the method 100 and/or one or more processes of the method 200.

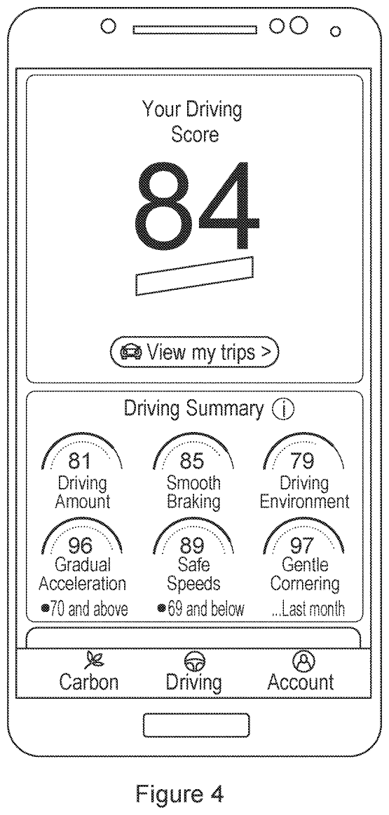

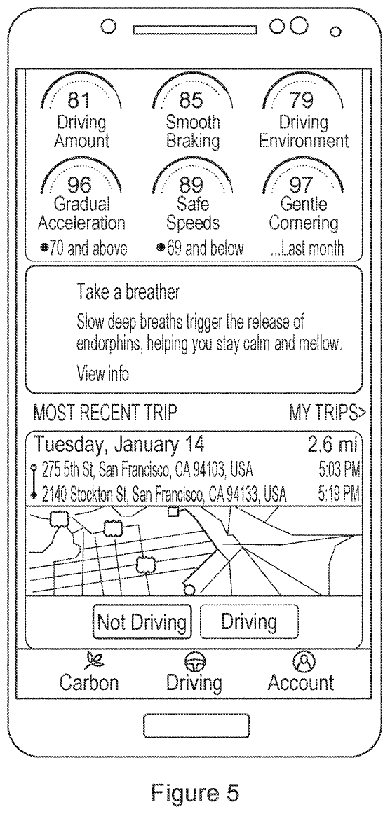

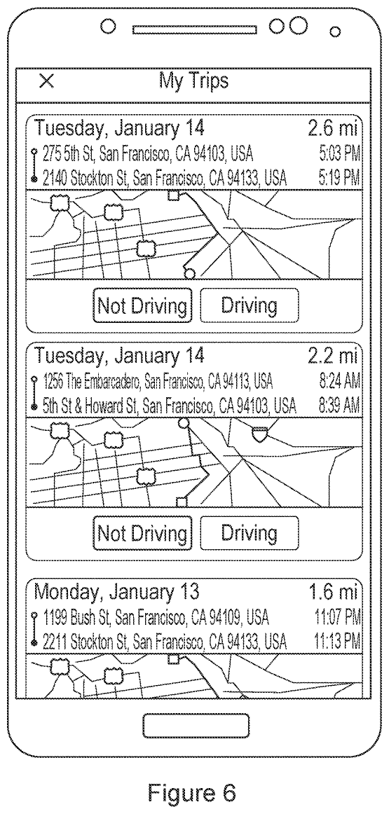

FIG. 4 to FIG. 11 are simplified diagrams showing a system (e.g., a computer program product) for providing renewing carbon offsets according to some embodiments of the present disclosure. These diagrams are merely examples. According to various embodiments, an application (“app”) is shown running on a mobile device of the user. For example, the app automatically logs vehicle trips taken by the user and calculates how much carbon pollution the user has created by driving. In some examples, as illustrated in FIG. 4 to FIG. 6, the app calculates a mindful driving score based at least in part upon how well the user drives and how much the user drives. In certain embodiments, the mindful driving score represents a percentage of carbon offset. For example, a mindful driving score of 0 to 40 represents a 0% offset, a mindful driving score of 40 to 90 represents a 0 to 100% offset, and a mindful driving score of 90+ represents a 100%+ offset.

In some embodiments, the user's mindful driving score is used to determine a number of trees that need be planted to remove the user's carbon pollution from the air. For example, the higher the mindful driving score (e.g., more mindful that the user drives), the more trees will be planted to remove the carbon pollution generated by the user's driving.

According to various embodiments, carbon stored by the planted trees are released back into the atmosphere when the trees die. For example, to compensate for this, an eternal tree is planted in which a tree is planted today while at the same time an investment is made. As an example, as the tree grows by removing carbon from the air, the investment also grows. For example, when the tree eventually dies, any profit from the investment is used to plant another tree. As an example, this process repeats indefinitely to ensure that there will always be a tree that exists to capture the carbon.

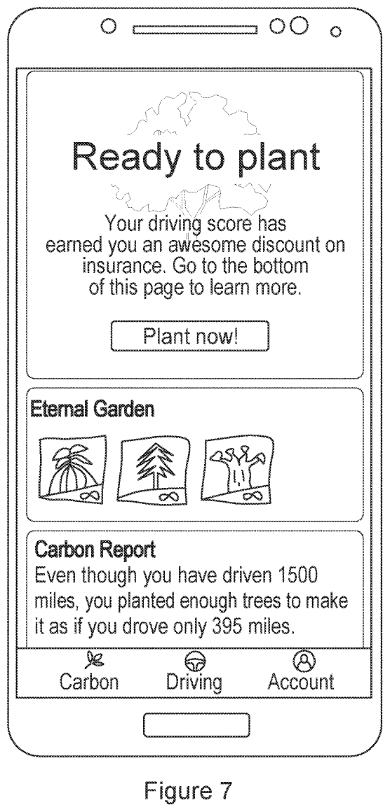

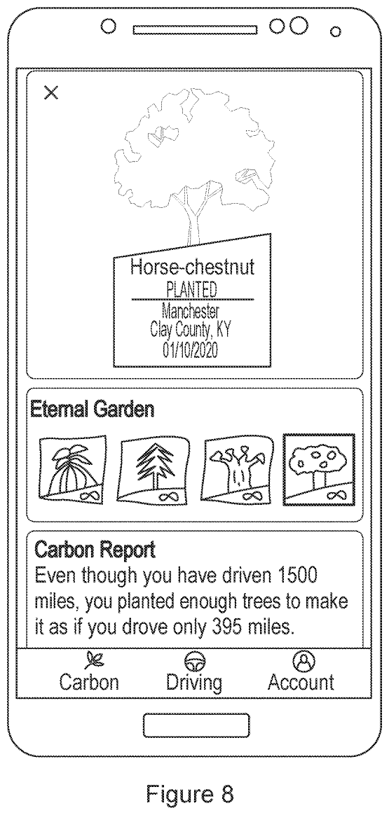

In certain embodiments, the eternal tree is planted in an eternal garden. For example, as illustrated in FIG. 7 and FIG. 8, tree icons representing actual planted trees are displayed in the eternal garden. As an example, trees will be replanted in the eternal garden when the trees die.

In some embodiments, the user receives a notification on the app indicating that the user can use the app to plant another eternal tree. For example, as illustrated in FIG. 7 and FIG. 8, the app lists a type of tree to be planted, a location where the tree is to be planted, and a date that the tree is to be planted. As an example, the app notifies the user that the eternal garden has a new tree.

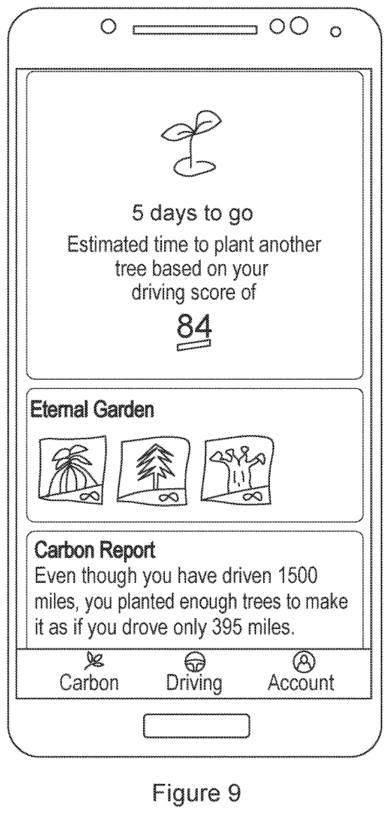

According to certain embodiments, the app indicates how many days are left before another eternal tree is planted as illustrated in FIG. 9. In some examples, a projected number of days until an eternal tree is planted is based at least in part upon various parameters such as: (i) miles driven on all vehicle trips taken since last tree planted (M); (ii) days since last tree planted (D); (iii) driving score (S); (iv) driving score factor (F) (e.g., if S<=20→F=0.0, if S=20-40→F=0.1, if S=40-50→F=0.5, if S=50-90→F=1.0, if S>=90→F=1.12); (v) number of trees purchased by the user (P); (vi) number of trees earned by the user (T); (vii) miles per tree (C/(F*S)); (viii) miles left (miles per tree−M); and/or (ix) days left (roundup ((D*miles left/M), 0).

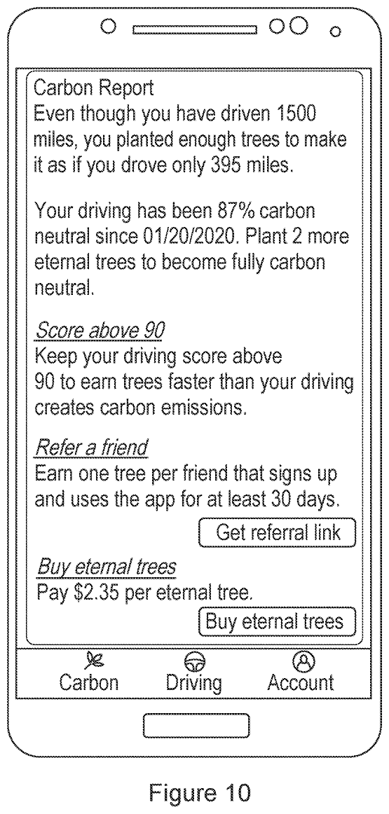

According to some embodiments, the app indicates that the user can become 100% carbon neutral by planting one or more eternal trees as illustrated in FIG. 10. For example, the app indicates a percentage (e.g., 75%) until the user becomes carbon neutral from a starting date.

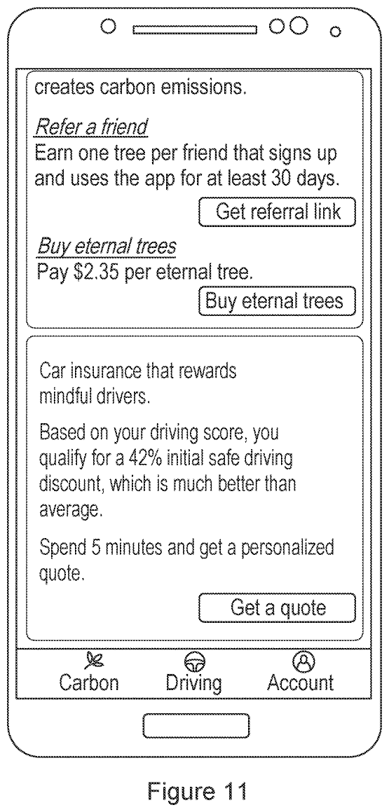

In some examples, as illustrated in FIG. 10, the user has an option to improve the mindful driving score above a certain threshold (e.g., 90) in order to start earning an eternal tree faster than producing carbon emissions. In certain examples, as illustrated in FIG. 10, the user has an option to invite a friend to earn an additional eternal tree (e.g., invite two friends to earn two additional eternal trees). In some examples, as illustrated in FIG. 10, the user can notify a friend that by driving safely, the user has earned one or more eternal trees for the eternal garden. In certain examples, as illustrated in FIG. 10, the user can tell the friend that the user can get another tree planted if the friend downloads the app. In some examples, as illustrated in FIG. 10, the user has an option to purchase an additional eternal tree (e.g., purchase two eternal trees for a specific price). In certain examples, as illustrated in FIG. 10, by planting one or more eternal trees, the app notifies the user that the user has driven an equivalent number of miles instead of the actual miles driven (e.g., planting of eternal trees has allowed the user to drive 195 miles instead of the actual 1500 miles). In some examples, as illustrated in FIG. 11, an initial safe driving discount or quote is customized for the user.

### III. One or More Additional Systems for Providing Renewing Carbon Offsets According to Certain Embodiments

According to various embodiments, a system (e.g., a computer program product) for providing renewing carbon offsets achieves the following objectives: (i) identify mindful drivers who can be given the best discounts on auto insurance and be invited to buy their car insurance, and/or (ii) support the overall mission of rewarding mindful choices in a way that also helps tackle carbon emissions produced by driving.

According to certain embodiments, the system for providing renewing carbon offsets includes the following use case scenario:
i. A driver wants to do something about climate change and feels bad about having to drive to work each day;
ii. A friend at work shows the driver the app and explains how driving mindfully causes the insurance provider to plant trees that neutralize the effects of driving;
iii. The driver downloads the app and works hard to improve the driver's mindful driving score;
iv. The driver is happy to see that good driving behaviors translate into actual trees being planted on the driver's behalf;
v. The driver receives a quote from the insurance provider based on an ad in the app that gives the driver a personalized driving discount according to the driver's mindful driving score in the app;
vi. The driver switches to the insurance provider after finding out that a lot of money can be saved by switching.

In some embodiments, the system for providing renewing carbon offsets performs the following functions: (i) buying carbon offsets, (ii) using any method other than eternal trees to remove carbon pollution, (iii) providing behavior change programs, (iv) focusing on carbon pollution not produced by driving, (v) providing gamification, and/or (vi) providing leaderboards.

In certain embodiments, the system for providing renewing carbon offsets includes the following components: (i) a mobile application, (ii) a website page, and/or (iii) a landing page.

In some embodiments, the system for providing renewing carbon offsets includes the following features:
i. Customers discover the app through word of mouth (e.g., main screen in the app is optimized for showing the app to a friend), digital advertisements (e.g., a singular iconic graphical element is implemented), and/or earned media (e.g., the app is explainable in a short amount of time such as 15 seconds);
ii. Customers download the app by searching for the app directly from an app store, starling at a landing page and tapping a link to go directly to the app store, obtaining a texted link from a friend as a referral, and/or downloading the app directly from an advertisement;
iii. Once downloaded, customers complete an onboarding experience in the following manner:
   a. Customers learn about the app which logs vehicle trips, calculates carbon emissions, determines a mindful driving score, enables the insurance provider to plant trees based upon the mindful driving score, and/or enables the insurance provider to plant every tree as an eternal tree;
   b. Customers provide information such as information about their vehicles (e.g., model/year/make), information about themselves (e.g., name, state, phone number, etc.), and/or their account information (e.g., email, password, etc.);
   c. Customers provide permissions such as location permissions and/or are notified about the need to select “always allow” according to settings in the mobile device;
   d. Customers are rewarded with an eternal tree (e.g., show an iconography of an eternal tree, show concept of an eternal forest, show concept of personal carbon neutrality, show that everyone starts at 100% carbon neutral, etc.);
iv. The app has following tabs:
   a. A carbon tab that details carbon impact (e.g., estimated time until next tree is earned, mindful driving score, eternal garden, carbon report including total miles driven to date, total miles offset to date, carbon neutral percentage, methods of planting additional eternal trees including planting based upon mindful driving score, planting based upon purchasing additional eternal trees, planting based upon referral to a friend, option to purchase auto insurance with a customized starting discount, etc.);
   b. A driving tab that details mindful driving (e.g., mindful driving score, driving summary, tips on mindful driving, most recent trip with individual trip option, etc.)
   c. An Account tab that details account and legal information (e.g., Profile, Billing, FAQ, privacy information, terms/conditions, etc.);
v. Customers have the following major interactions with the app:
   a. A user plants an eternal tree in the eternal garden in which the user is notified that a new tree is ready to be planted by a push notification, the user opens the app to see an iconic visualization of a fully-grown eternal tree along with a “Plant” button, the user taps the “Plant” button to view that the tree has a graphical flourish, information about the specific tree, and/or an information box about the insurance company, and/or the user is notified that another eternal tree cannot grow if the eternal tree is not planted by the user;
   b. The user is notified that the app is not in the correct state to log trip data (e.g., the user is notified that eternal trees cannot grow while the app is in an incorrect state);
   c. The user refers a friend in which the user texts a link to a friend and the friend downloads the app using the link, and/or the user receives a notice when the friend downloads the app and obtains a bonus eternal tree once the friend logs 30 consecutive days of app usage;
   d. The user buys eternal trees in which the user taps a buy button on the carbon tab, the user selects a number of eternal trees to buy, the user either enters credit card information, the user confirms the purchase, additional trees are placed in the user's eternal garden, payment receipt is available, and/or carbon report is updated to include the new trees;
   e. The user buys an insurance policy in which the user is notified about how the user qualifies for a customized starting discount if purchasing insurance after planting an eternal tree, the user taps the link which directs the user to a custom landing page, the user starts the insurance quote flow, and/or the user is given a unique customized starting discount;
vi. Customers have the following minor interactions with the app:
   a. Classify trips;
   b. Change payment information;
   c. Change account information;
   d. View past payments;
   e. View tips/feedback in the app;
   f. View mindful driving subscores.

In certain embodiments, the experience of the app for users who do not live in a predetermined geographical would be similar except that there would be a note in a section of the carbon tab to indicate that the users are outside of the predetermined geographical area in which the insurance company is currently paying for eternal tree costs. For example, the note indicates that the eternal trees are illustrative only and the only available way to offset carbon is to purchase the eternal trees through the app.

In some embodiments, the system for providing renewing carbon offsets includes the following functions:

i. Ordered by priority;

ii. User notification is sent if the app is not in a correct state that can log trips;

iii. One free eternal tree for completing an insurance quote;

iv. One free eternal tree for referring a friend to download the app;

v. Ability to purchase eternal trees.

In certain embodiments, the system for providing renewing carbon offsets performs the following functions:
i. The app can be integrated into other apps;
ii. Users can post carbon report to social media including the eternal garden;
iii. Users can filter trips by trip start/end locations to determine if the miles calculated are valid to offset;
iv. A program transparency screen that reports the total number of eternal trees planted, investment decisions, and/or yearly returns;
v. Creation of an entity for tax purposes.

According to various embodiments, the onboarding experience for the app will take as long as needed to explain the concepts of the app to the user. For example, the process of planting an external tree should be 15 seconds or less. As an example, the process of explaining the app should be 30 seconds or less. For example, the process of showing a friend the main screen of the app should be 30 seconds or less. As an example, the process of reviewing the mindful driving scores should be 15 seconds or less. For example, the process of referring a friend should be 15 seconds or less.

### IV. Examples of Certain Embodiments of the Present Disclosure

According to certain embodiments, a method for providing renewing carbon offsets includes collecting driving data for one or more vehicle trips made by a user. The driving data include information related to a mindful driving behavior of the user. Also, the method includes analyzing the driving data to determine a level of mindful driving of the user. Additionally, the method includes determining a level of carbon offset reward based at least in part upon the level of mindful driving of the user and an amount of total carbon emission of the user. Moreover, the method includes providing an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a first time duration that is shorter than or equal to a first lifespan corresponding to each of the one or more first trees. For example, the method is implemented according to at least FIG. 1A and/or FIG. 1B.

As an example, the method for providing renewing carbon offsets further includes using the first amount for planting the one or more first trees at the first time. During the first time duration, the method includes investing the second amount to become a third amount including a first part and a second part. After the first time duration, the method includes using the first part of the third amount for planting the one or more second trees at the second time. Moreover, the method includes investing the second part of the third amount for planting one or more third trees at a third time. The second time precedes the third time by a second time duration that is shorter than or equal to a second lifespan corresponding to each of the one or more second trees. For example, the method is implemented according to at least FIG. 1A and/or FIG. 1B.

According to some embodiments, a method for providing renewing carbon offsets includes collecting driving data for one or more vehicle trips made by a user. The driving data include information related to a mindful driving behavior of the user. Also, the method includes analyzing the driving data to determine a level of mindful driving of the user. Additionally, the method includes determining a level of carbon offset reward based at least in part upon the level of mindful driving of the user and an amount of total carbon emission of the user. Moreover, the method includes providing an amount of carbon offset reward based at least in part upon the level of carbon offset reward and the amount of total carbon emission. The amount of carbon offset reward includes a first amount for planting one or more first trees at a first time and a second amount for planting one or more second trees at a second time. Each of the one or more first trees corresponds to a first lifespan and each of the one or more second trees corresponds to a second lifespan. After the first lifespan, the one or more second trees remain alive as replacements for the one or more first trees until the end of the second lifespan. For example, the method is implemented according to at least FIG. 2.

According to certain embodiments, a computing device for providing renewing carbon offsets includes one or more processors and a memory that stores instructions for execution by the one or more processors. The instructions, when executed, cause the one or more processors to collect driving data for one or more vehicle trips made by a user. The driving data include information related to a mindful driving behavior of the user. Also, the instructions, when executed, cause the one or more processors to analyze the driving data to determine a level of mindful driving of the user. Additionally, the instructions, when executed, cause the one or more processors to determine a level of carbon offset reward based at least in part upon the level of mindful driving of the user and an amount of total carbon emission of the user. Moreover, the instructions, when executed, cause the one or more processors to provide an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a time duration that is shorter than or equal to a lifespan of each of the one or more first trees. For example, the computing device is implemented according to at least FIG. 3.

According to some embodiments, a non-transitory computer-readable medium stores instructions for providing renewing carbon offsets. The instructions are executed by one or more processors of a computing device. The non-transitory computer-readable medium includes instructions to collect driving data for one or more vehicle trips made by a user. The driving data include information related to a mindful driving behavior of the user. Also, the non-transitory computer-readable medium includes instructions to analyze the driving data to determine a level of mindful driving of the user. Additionally, the non-transitory computer-readable medium includes instructions to determine a level of carbon offset reward based at least in part upon the level of mindful driving of the user and an amount of total carbon emission of the user. Moreover, the non-transitory computer-readable medium includes instructions to provide an amount of carbon offset reward based at least in part upon the level of carbon offset reward and the amount of total carbon emission. The amount of carbon offset reward includes a first amount for planting one or more first trees at a first time and a second amount for planting one or more second trees at a second time. The first time precedes the second time by a time duration that is shorter than or equal to a lifespan of each of the one or more first trees. For example, the non-transitory computer-readable medium is implemented according to at least FIG. 1A, FIG. 1B and/or FIG. 3.

### V. Examples of Machine Learning According to Certain Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### VI. Additional Considerations According to Certain Embodiments

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for providing renewing carbon offsets, the method comprising:
collecting, by a computing device, driving data for one or more first vehicle trips made by a user, the driving data including information related to a mindful driving behavior of the user;
analyzing, by the computing device, the driving data to determine a level of mindful driving of the user;
determining, by the computing device, a level of carbon offset reward based at least in part upon the level of mindful driving of the user;
determining, by the computing device, an amount of total carbon emission of the user; and
providing, by the computing device, an amount of carbon offset reward based at least in part upon the level of carbon offset reward and the amount of total carbon emission,
wherein:
the amount of carbon offset reward includes a first amount for planting one or more first trees at a first time and a second amount for planting one or more second trees at a second time;
each of the one or more first trees corresponds to a first lifespan;
the first time precedes the second time by a first time duration; and
the first time duration is shorter than or equal to the first lifespan.

2. The method of claim 1; further comprising:
using, by the computing device, the first amount for planting the one or more first trees at the first time;
during the first time duration, investing, by the computing device, the second amount to become a third amount including a first part and a second part;
after the first time duration, using, by the computing device, the first part of the third amount for planting the one or more second trees at the second time; and
investing, by the computing device, the second part of the third amount for planting one or more third trees at a third time,
wherein:
each of the one or more second trees corresponds to a second lifespan;
the second time precedes the third time by a second time duration; and
the second time duration is shorter than or equal to the second lifespan.

3. The method of claim 1, wherein the determining, by the computing device, the amount of total carbon emission of the user includes:
collecting fuel-consumption driving data for a vehicle operated by the user for one or more second vehicle trips made by the user;
collecting vehicle information of the vehicle;
analyzing the fuel-consumption driving data and the vehicle information; and
determining the amount of total carbon emission based at least in part upon the fuel-consumption driving data and the vehicle information.

4. The method of claim 3, wherein the one or more first vehicle trips are the same as the one or more second vehicle trips.

5. The method of claim 3, wherein the one or more first vehicle trips are different from the one or more second vehicle trips.

6. The method of claim 1, wherein the determining, by the computing device, the amount of total carbon emission of the user includes:
collecting fueling data for one or more second vehicle trips made by the user; and
analyzing the fueling data to determine the amount of total carbon emission.

7. The method of claim 1, further comprising:
determining, by the computing device, a level of insurance discount based at least in part upon the level of mindful driving of the user; and
generating, by the computing device, an adjustment to an insurance premium for the user based at least in part upon the level of insurance discount and an amount of insurance premium.

8. A computing device for providing renewing carbon offsets, the computing device comprising:
one or more processors; and
a memory storing instructions that, when executed by the one or more processors, cause the one or more processors to:
collect driving data for one or more first vehicle trips made by a user, the driving data including information related to a mindful driving behavior of the user;
analyze the driving data to determine a level of mindful driving of the user;
determine a level of carbon offset reward based at least in part upon the level of mindful driving of the user;
determine an amount of total carbon emission of the user; and
provide an amount of carbon offset reward based at least in part upon the level of carbon offset reward and the amount of total carbon emission,
wherein:
the amount of carbon offset reward includes a first amount for planting one or more first trees at a first time and a second amount for planting one or more second trees at a second time;
each of the one or more first trees corresponds to a first lifespan;
the first time precedes the second time by a first time duration; and
the first time duration is shorter than or equal to the first lifespan.

9. The computing device of claim 8, wherein the instructions further comprise instructions that, when executed by the one or more processors, cause the one or more processors to:
use the first amount for planting the one or more first trees at the first time;
during the first time duration, invest the second amount to become a third amount including a first part and a second part;
after the first time duration, use the first part of the third amount for planting the one or more second trees at the second time; and
invest the second part of the third amount for planting one or more third trees at a third time,
wherein:
each of the one or more second trees corresponds to a second lifespan;
the second time precedes the third time by a second time duration; and
the second time duration is shorter than or equal to the second lifespan.

10. The computing device of claim 8, wherein the instructions that cause the one or more processors to determine the amount of total carbon emission of the user further comprise instructions that cause the one or more processors to:
collect fuel-consumption driving data for a vehicle operated by the user for one or more second vehicle trips made by the user;
collect vehicle information of the vehicle;
analyze the fuel-consumption driving data and the vehicle information; and
determine the amount of total carbon emission based at least in part upon the fuel-consumption driving data and the vehicle information.

11. The computing device of claim 10, wherein the one or more first vehicle trips are the same as the one or more second vehicle trips.

12. The computing device of claim 10, wherein the one or more first vehicle trips are different from the one or more second vehicle trips.

13. The computing device of claim 8, wherein the instructions that cause the one or more processors to determine the amount of total carbon emission of the user further comprise instructions that cause the one or more processors to:
collect fueling data for one or more second vehicle trips made by the user; and
analyze the fueling date to determine the amount of total carbon emission.

14. The computing device of claim 8, wherein the instructions further comprise instructions that, when executed by the one or more processors, cause the one or more processors to:
determine a level of insurance discount based at least in part upon the level of mindful driving of the user; and
generate an adjustment to an insurance premium for the user based at least in part upon the level of insurance discount and an amount of insurance premium.

15. A method for providing renewing carbon offsets, the method comprising:
collecting, by a computing device, driving data for one or more first vehicle trips made by a user, the driving data including information related to a mindful driving behavior of the user;
analyzing, by the computing device, the driving data to determine a level of mindful driving of the user;
determining, by the computing device, a level of carbon offset reward based at least in part upon the level of mindful driving of the user;
determining, by the computing device, an amount of total carbon emission of the user; and
providing, by the computing device, an amount of carbon offset reward based at least in part upon the level of carbon offset reward and the amount of total carbon emission,
wherein:
the amount of carbon offset reward includes a first amount for planting one or more first trees at a first time and a second amount for planting one or more second trees at a second time;
each of the one or more first trees corresponds to a first lifespan;
each of the one or more second trees corresponds to a second lifespan; and
after the first lifespan, the one or more second trees remain alive as replacements for the one or more first trees until the end of the second lifespan.

16. The method of claim 15, wherein the providing, by the computing device, the amount of carbon offset reward based at least in part upon the level of carbon offset reward and the amount of total carbon emission includes:
using one part of the second amount to plant the one or more second trees at the second time; and
investing the other part of the second amount to plant one or more third trees,
wherein:
the one or more third trees corresponds to a third lifespan; and
after the second lifespan, the one or more third trees remain alive as replacements for the one or more second trees until the end of the third lifespan.

17. The method of claim 15, wherein the determining, by the computing device, the amount of total carbon emission of the user includes:
collecting fuel-consumption driving data for a vehicle operated by the user for one or more second vehicle trips made by the user;
collecting vehicle information of the vehicle;
analyzing the fuel-consumption driving data and the vehicle information; and
determining the amount of total carbon emission based at least in part upon the fuel-consumption driving data and the vehicle information.

18. The method of claim 17, wherein the one or more first vehicle trips are the same as the one or more second vehicle trips.

19. The method of claim 17, wherein the one or more first vehicle trips are different from the one or more second vehicle trips.

20. The method of claim 15, wherein the determining, by the computing device, the amount of total carbon emission of the user includes:
collecting fueling data for one or more second vehicle trips made by the user; and
analyzing the fueling data to determine the amount of total carbon emission.

21. A non-transitory computer-readable medium storing instructions for providing renewing carbon offsets, the instructions when executed by one or more processors of a computing device, cause the computing device to:
collect driving data for one or more first vehicle trips made by a user, the driving data including information related to a mindful driving behavior of the user;
analyze the driving data to determine a level of mindful driving of the user;
determine a level of carbon offset reward based at least in part upon the level of mindful driving of the user;
determine an amount of total carbon emission of the user; and
provide an amount of carbon offset reward based at least in part upon the level of carbon offset reward and the amount of total carbon emission,
wherein:
the amount of carbon offset reward includes a first amount for planting one or more first trees at a first time and a second amount for planting one or more second trees at a second time;
each of the one or more first trees corresponds to a first lifespan;
the first time precedes the second time by a first time duration; and
the first time duration is shorter than or equal to the first lifespan.
